(19) United States
(12) Patent Application Publication
(10) Pub. No.: US 2023/0168543 A1
(43) Pub. Date: Jun. 1, 2023

(54) OPTICAL ELEMENT

(71) Applicant: AGC Inc., Tokyo (JP)

(72) Inventors: Kenta SEKIKAWA, Fukushima (JP); Hiromichi NAGAYAMA, Fukushima (JP); So ISHIDO, Fukushima (JP)

(73) Assignee: AGC Inc., Tokyo (JP)

(21) Appl. No.: 18/162,783

(22) Filed: Feb. 1, 2023

Related U.S. Application Data
(63) Continuation of application No. PCT/JP2021/028750, filed on Aug. 3, 2021.

(30) Foreign Application Priority Data
Aug. 7, 2020 (JP) 2020-135092
Oct. 28, 2020 (JP) 2020-180362

(51) Int. Cl. G02F 1/1337

(52) U.S. Cl. CPC G02F 1/133711; G02F 1/133776

(57) ABSTRACT

An optical element includes a transparent substrate; an alignment layer formed over the transparent substrate; and a liquid crystal layer formed over the alignment layer. A plurality of grooves parallel to each other for aligning liquid crystal molecules of the liquid crystal layer are formed over a surface of the alignment layer in contact with the liquid crystal layer. A pitch of the grooves is greater than or equal to 10 nm and less than or equal to 600 nm. The alignment layer is formed of a copolymer of an energy curable composition and contains fluorine on the surface.

### CROSS-REFERENCE TO RELATED APPLICATION

The present application is a continuation application of International Application No. PCT/JP2021/028750, filed Aug. 3, 2021, which claims priority to Japanese Patent Applications No. 2020-135092 filed Aug. 7, 2020, and No. 2020-180362 filed Oct. 28, 2020. The contents of these applications are incorporated herein by reference in their entirety.

### BACKGROUND OF THE INVENTION

### 1. Field of the Invention

The present disclosure relates to an optical element.

### 2. Description of the Related Art

Japanese translation of PCT international application publication No. JP-T-2005-516236 discloses a method of manufacturing an optical element including (A) forming an alignment layer having a fine groove structure; (B) laminating a coating material exhibiting a liquid crystal phase on the alignment layer; and (C) curing the coating material layer to fix an alignment of the liquid crystal phase.

Japanese unexamined patent application publication No. 2013-7781 discloses a liquid crystal device, in which liquid crystal molecules are interposed between a first substrate and a second substrate, and light waves are modulated by birefringence of the liquid crystal. The first substrate or the second substrate is provided with a grating structure having a pitch shorter than the wavelength of the light wave. The grating structure is formed by using a nano-imprint method. With the grating structure, an alignment direction of liquid crystal molecules can be controlled, and the phase of the light waves passing through the liquid crystal can be controlled.

Japanese translation of PCT international application publication No. JP-T-2016-509966 discloses a method of manufacturing a liquid crystal alignment film including a step of injecting a liquid crystal material onto a non-flat surface of an alignment film to form a liquid crystal layer. The method of manufacturing the alignment film includes (A) transferring a concave-convex pattern of a mold to a layer to be transferred; (B) forming a titanium dioxide layer on the concave-convex pattern; (C) deforming the titanium dioxide layer to have a curved surface; and (D) etching the deformed titanium dioxide layer having the curved surface, to form a fine concave-convex pattern on the curved surface. The liquid crystal material is injected onto the concave-convex pattern.

### SUMMARY OF THE INVENTION

### Problems to be Solved by the Invention

Conventionally, it has been studied to form a fine groove structure in an alignment layer in order to align liquid crystal molecules.

According to an aspect of the present disclosure, a technique for increasing the alignment restricting force of an alignment layer, and thereby increasing a retardation of the liquid crystal layer can be provided.

### Means for Solving the Problem

According to an aspect of the present disclosure, an optical element includes a transparent substrate; an alignment layer formed over the transparent substrate; and a liquid crystal layer formed over the alignment layer. A plurality of grooves parallel to each other for aligning liquid crystal molecules of the liquid crystal layer are formed over a surface of the alignment layer in contact with the liquid crystal layer. A pitch of the grooves is 10 nm-600 nm. The alignment layer is formed of a copolymer of an energy curable composition and contains fluorine on the surface.

According to another aspect of the present disclosure, an optical element includes a transparent substrate, an alignment layer formed over the transparent substrate, and a liquid crystal layer formed over the alignment layer. A plurality of grooves parallel to each other for aligning liquid crystal molecules of the liquid crystal layer are formed over a surface of the alignment layer in contact with the liquid crystal layer. A pitch of the grooves is 10 nm-600 nm. The alignment layer is formed of a copolymer of an energy curable composition and includes a surfactant.

### Effects of the Invention

According to an aspect of the present disclosure, it is possible to improve the alignment restricting force of the alignment layer by the fluorine or the surfactant contained in the alignment layer, and increase a retardation of the liquid crystal layer.

### BRIEF DESCRIPTION OF DRAWINGS

Other objects and further features of the present disclosure will be apparent from the following detailed description when read in conjunction with the accompanying drawings, in which:

FIG. 1 is a cross-sectional view showing an optical element according to a first embodiment;

FIG. 2A is a perspective view showing an example of a transparent substrate and an alignment layer;

FIG. 2B is a perspective view showing an example of liquid crystal molecules aligned by the alignment layer shown in FIG. 2A;

FIG. 3A is a cross-sectional view showing a state before a retardation plate and a three-dimensional structure of the optical element according to a second embodiment are bonded;

FIG. 3B is a cross-sectional view of the optical element formed by bonding the retardation plate and the three-dimensional structure shown in FIG. 3A;

FIG. 3C is a plan view of the optical element shown in FIG. 3B;

FIG. 4A is a cross-sectional view showing an optical element according to a first variation of the second embodiment;

FIG. 4B is a cross-sectional view showing an optical element according to a second variation of the second embodiment;

FIG. 4C is a cross-sectional view showing an optical element according to a third variation of the second embodiment;

FIG. 5A is a cross-sectional view showing a state before a retardation plate and a three-dimensional structure of an optical element according to a reference embodiment are bonded;

FIG. 5B is a cross-sectional view showing the optical element formed by bonding the retardation plate and the three-dimensional structure shown in FIG. 5A;

FIG. 5C is a plan view showing a distribution of the retardation Rd of the optical element shown in FIG. 5B;

FIG. 6A is a cross-sectional view showing a state before a retardation plate and a three-dimensional structure of an optical element according to a variation of the reference embodiment are bonded;

FIG. 6B is a cross-sectional view showing the optical element formed by bonding the retardation plate and the three-dimensional structure shown in FIG. 6A;

FIG. 6C is a plan view showing a distribution of Rd of the optical element shown in FIG. 6B;

FIG. 7A is a cross-sectional view of an optical element according to a third embodiment;

FIG. 7B is an enlarged cross-sectional view of a region B in FIG. 7A;

FIG. 7C is an enlarged cross-sectional view of a region C in FIG. 7A;

FIG. 8A is a cross-sectional view of an optical element according to a variation of the third embodiment;

FIG. 8B is an enlarged cross-sectional view of a region B in FIG. 8A; and

FIG. 8C is an enlarged cross-sectional view of a region C in FIG. 8A.

### DESCRIPTION OF THE PREFERRED EMBODIMENT

Hereinafter, embodiments of the present disclosure will be described with reference to the drawings. In the drawings, the same or corresponding components are denoted by the same reference numeral, and description thereof may be omitted. In addition, in the specification, “−” indicating a numerical range means that numerical values described before and after “−” are included as a lower limit value and an upper limit value.

### First Embodiment

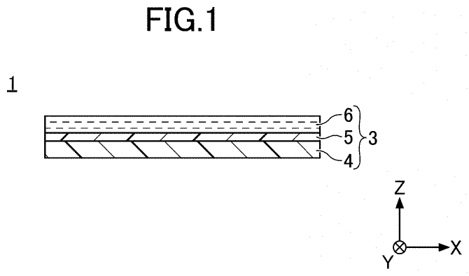

An optical element 1 according to the first embodiment will be described with reference to FIG. 1. The optical element 1 includes a retardation plate 3. The retardation plate 3 has, for example, a flat plate shape. The retardation plate 3 includes, for example, a transparent substrate 4, an alignment layer 5 formed over the transparent substrate 4, and a liquid crystal layer 6 formed over the alignment layer 5.

The retardation plate 3 has a slow axis and a fast axis. When viewed in the Z-axis direction, the slow axis is in the X-axis direction and the fast axis is in the Y-axis direction. The refractive index is the greatest in the slow axis direction, and the refractive index is the smallest in the fast axis direction.

The retardation plate 3 is, for example, a ¼ wavelength plate. The ¼ wavelength plate and a linearly polarizing plate (not illustrated) may be used in combination. The absorption axis of the linearly polarizing plate and the slow axis of the ¼ wavelength plate are arranged so as to be shifted from each other by 45°. The linearly polarizing plate and the ¼ wavelength plate constitute a circularly polarizing plate.

The transparent substrate 4 is formed of, for example, a glass substrate or a resin substrate. The glass substrate or the resin substrate may be configured to have a reflection function or an absorption function with respect to any one or two or more of infrared light, visible light, and ultraviolet light, and transmit light in a specific wavelength band. The transparent substrate 4 may have a single-layer structure of a single substrate, or may have a multi-layer structure in which a film providing a reflection function or an absorption function to a main substrate (glass substrate or resin substrate) is laminated, and transmits light in a specific wavelength band. A film that provides an antifouling function or the like, in addition to the reflection function and the absorption function, may be laminated in the transparent substrate 4.

For example, the transparent substrate 4 may further include a resin film or an inorganic film in addition to the glass substrate or the resin substrate. The resin film is, for example, a film having a function of a color tone correction filter, a base film containing a silane coupling agent or the like, or an antifouling film. The resin film is formed by, for example, screen printing, vapor deposition, spray coating, or spin coating. The inorganic film is, for example, a metal oxide film having a function of an optical interference film (antireflection film or wavelength selection filter). The inorganic film is formed by, for example, a sputtering method, vapor deposition, or a CVD method.

The transparent substrate 4 is preferably a resin substrate from the viewpoint of bending processability. Specifically, the resins of the resin substrate include, for example, polymethyl methacrylate (PMMA), triacetylcellulose (TAC), cycloolefin polymer (COP), cycloolefin copolymer (COC), polyethylene terephthalate (PET), and polycarbonate (PC).

A retardation of the transparent substrate 4 is, for example, 5 nm or less, and preferably 3 nm or less. The retardation of the transparent substrate 4 is preferably as small as possible from the viewpoint of reducing variation in color tone, and may be zero. The retardation of the transparent substrate 4 is measured by, for example, a parallel Nicol rotation method.

The glass-transition temperature Tgf of the transparent substrate 4 is, for example, 80° C.-200° C., and preferably 90° C.-160° C. When the glass-transition temperature Tgf is within the above-described range, good bending processability is obtained. The glass-transition temperature of the transparent substrate 4 is measured by, for example, thermomechanical analysis (TMA).

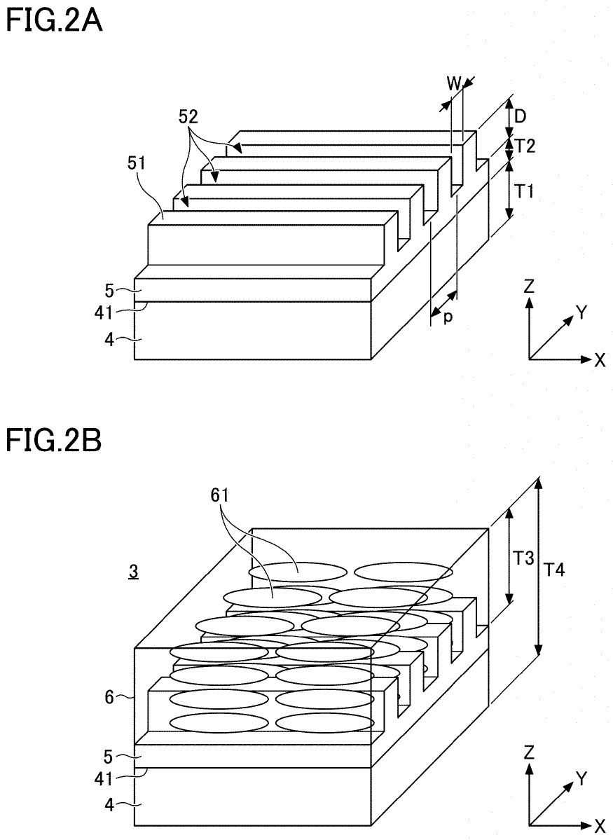

The thickness T1 of the transparent substrate 4 (see FIG. 2A) is, for example, 0.01 mm-0.3 mm, preferably 0.02 mm-0.1 mm, and more preferably 0.03 mm-0.09 mm. When the thickness T1 is within the above-described range, both bending processability and handling property can be achieved.

The alignment layer 5 aligns liquid crystal molecules of the liquid crystal layer 6. A plurality of grooves 52 parallel to each other for aligning liquid crystal molecules of the liquid crystal layer 6 are formed over a surface 51 of the alignment layer 5 in contact with the liquid crystal layer 6. The plurality of grooves 52 are formed in a stripe pattern, for example. When viewed in the Z-axis direction, the longitudinal direction of the groove 52 is parallel to the X-axis direction, and the width direction of the groove 52 is parallel to the Y-axis direction.

The degree of parallelism of the grooves 52 is, for example, 0°-5°, preferably 0°-3°, and more preferably 0°-1°. The parallelism of the grooves 52 is a maximum value of an angle formed by two adjacent grooves 52 when viewed in the Z-axis direction. The closer to 0° the angle formed by two adjacent grooves 52 is, the more the parallelism is excellent.

The depth D of the groove 52 is, for example, 3 nm-500 nm, preferably 5 nm-300 nm, and more preferably 10 nm-150 nm. When the depth D is greater than or equal to 3 nm, the alignment restricting force is large and the liquid crystal molecules are easily aligned. On the other hand, when the depth D is less than or equal to 500 nm, the transferability of the concave-convex pattern of the mold is excellent. When the depth D is less than or equal to 500 nm, diffracted light is less likely to occur.

The pitch p of the groove 52 is, for example, 10 nm-600 nm, preferably 50 nm-300 nm, and more preferably 80 nm-200 nm. When the pitch p is less than or equal to 600 nm, the alignment restricting force is large and liquid crystal molecules are easily aligned. Further, when the pitch p is less than or equal to 300 nm, diffracted light is less likely to occur. On the other hand, when the pitch p is greater than or equal to 10 nm, the concave-convex pattern of the mold is easily formed.

The opening width W of the groove 52 is, for example, 5 nm-500 nm, preferably 20 nm-200 nm, and more preferably 30 nm-150 nm. The difference between the pitch p and the opening width W (p-W, where p>W) is an interval between the grooves 52 (a width of a convex portion that separates adjacent two grooves 52).

A cross section perpendicular to the longitudinal direction (X-axis direction) of the groove 52 has a rectangular shape in FIGS. 2A and 2B, but may have a triangular shape. The width of the groove 52 having a triangular cross section increases as the depth decreases. In this case, the mold used in the imprint method can be easily peeled.

The alignment layer 5 is formed of a copolymer of an energy curable composition. The energy curable composition is a photocurable composition or a thermally curable composition. In particular, a photocurable composition is preferable from the viewpoint of excellent processability, heat resistance and durability. The photocurable composition is, for example, a composition containing a monomer, a photopolymerization initiator, a solvent, and if necessary, an additive (for example, a surfactant, a polymerization inhibitor, an antioxidant, an ultraviolet absorber, a light stabilizer, or an antifoaming agent). As the photocurable composition, for example, a composition described in paragraphs 0028 to 0060 of Japanese Patent No. 5978761 is used. The photocurable composition includes, for example, a fluorine-containing monomer containing fluorine and a photocurable monomer not containing fluorine.

The alignment layer 5 contains fluorine on a surface 51 in contact with the liquid crystal layer 6. The fluorine is derived from a fluorine-containing monomer. The fluorine tends to concentrate on the surface 51 of the alignment layer 5 rather than inside the alignment layer 5. The fluorine lowers a surface free energy of the surface 51 of the alignment layer 5 and lowers a wettability of the liquid crystal composition which is described later. As a result, the liquid crystal composition is brought into an energetically most stable state, i.e., a state in which liquid crystal molecules are aligned in parallel with each other. Therefore, the alignment restricting force by the alignment layer 5 can be enhanced, and the retardation of the liquid crystal layer 6 can be increased.

The fluorine concentration FC of the surface 51 of the alignment layer 5 is, for example, 0.1 atom %-50 atom %, preferably 1 atom %-40 atom %, more preferably 2 atom %-30 atom %, and even more preferably 5 atom %-20 atom %. When the concentration FC is 0.1 atom % or more, the effect of improving the alignment restricting force can be obtained. On the other hand, when the concentration FC is 50 atom % or less, white turbidity of the alignment layer 5 can be suppressed. When the concentration FC is 50 atom % or less, adhesion between the alignment layer 5 and the transparent substrate 4 and adhesion between the alignment layer 5 and the liquid crystal layer 6 can be improved. For example, in the case where the alignment layer 5 was formed of PTFE (polytetrafluoroethylene) and the concentration FC was 58 atom %, when the liquid crystal composition L1 (see Examples, described later) was applied to the alignment layer 5 by a spin coating method, the liquid crystal composition L1 did not adhere to the alignment layer 5 and was peeled off.

The alignment layer 5 may contain a surfactant instead of or in addition to the fluorine. The surfactant is evenly dispersed in the alignment layer 5. The surfactant is, for example, a fluorine-based or silicone-based surfactant. Similarly to the fluorine, the surfactant lowers the surface free energy of the surface 51 of the alignment layer 5, and lowers the wettability of the liquid crystal composition, which will be described later. As a result, the liquid crystal composition is brought into an energetically most stable state, i.e., a state in which liquid crystal molecules are aligned in parallel with each other. Therefore, the alignment restricting force by the alignment layer 5 can be enhanced, and the retardation of the liquid crystal layer 6 can be increased.

The content SC of the surfactant in the alignment layer 5 is, for example, 0.05 mass %-4 mass %, preferably 0.1 mass %-3 mass %, and more preferably 0.2 mass %-2 mass %. When the content SC is 0.05 mass % or more, the effect of improving the alignment restricting force of the alignment layer 5 can be obtained. On the other hand, when the content SC is 4 mass % or less, a plurality of components constituting the energy-curable composition are easily mixed. Unlike the monomer, the surfactant does not appreciably polymerize. Therefore, when the energy-curable composition does not contain a solvent, the content SC of the surfactant in the energy-curable composition and the content SC of the surfactant in the alignment layer 5 are substantially the same.

The alignment layer 5 is formed by, for example, an imprint method. In the imprint method, the energy-curable composition is sandwiched between the transparent substrate 4 and the mold, the concave-convex pattern of the mold is transferred to the energy-curable composition, and the energy-curable composition is cured. When the imprint method is used, the size and the shape of the groove 52 can be controlled with high accuracy, and contamination of foreign matter can be suppressed.

The energy-curable composition may be applied to the transparent substrate 4 or may be applied to the mold. The coating methods include, for example, spin coating, bar coating, dip coating, casting, spray coating, bead coating, wire bar coating, blade coating, roller coating, curtain coating, slit die coating, gravure coating, slit reverse coating, Micro Gravure™ coating, and comma coating.

The thickness T2 of the alignment layer 5 (see FIG. 2A) is, for example, 1 nm-20 μm, preferably 50 nm-10 μm, and more preferably 100 nm-5 μm. The thickness T2 of the alignment layer 5 is measured in the direction normal to the surface 41 of the transparent substrate 4, on which the alignment layer 5 is formed, at each point on the surface 41. When the alignment layer 5 has grooves 52, the thickness T2 of the alignment layer 5 in the present specification refers to a distance between a bottom of the grooves 52 and the surface 41 of the transparent substrate 4. When the thickness of the alignment layer 5 is 20 μm or less, processability is excellent.

The glass-transition temperature Tg_al of the alignment layer 5 is, for example, 40° C.-200° C., preferably 50° C.-160° C., and more preferably 70° C.-150° C. When the transition temperature Tg_al is within the above-described range, bending processability is good. The glass-transition temperature of the alignment layer 5 is measured by, for example, the TMA.

The liquid crystal layer 6 has a slow axis and a fast axis. The retardation Rd is a product of a difference Δn between the refractive index ne of the slow axis and the refractive index no of the fast axis (Δn=ne-no) and a size d of the liquid crystal layer 6 in the Z-axis direction. That is, the retardation Rd is obtained from a relation Rd=Δn×d.

As shown in FIG. 2B, the liquid crystal layer 6 includes a plurality of liquid crystal molecules 61 aligned in parallel to each other according to the alignment layer 5. When viewed in the Z-axis direction, the long-axis direction of the liquid crystal molecules 61 is parallel to the X-axis direction, and the short-axis direction of the liquid crystal molecules 61 is parallel to the Y-axis direction. The liquid crystal molecules 61 are rod-shaped liquid crystals in the present embodiment, but may be discotic liquid crystals.

The liquid crystal layer 6 is formed by applying and drying a liquid crystal composition. The liquid crystal composition contains a photocurable liquid crystal containing an acrylic group or a methacrylic group. The liquid crystal composition may contain a component that does not exhibit a liquid crystal phase by itself. It is sufficient that a liquid crystal phase is generated by polymerization. The components that do not exhibit a liquid crystal phase includes, for example, monofunctional (meth) acrylate, bifunctional (meth) acrylate, and (meth) acrylate having three or more functional groups. The liquid crystal composition may contain photocurable monomer. The polymerizable liquid crystal composition may contain an additive. The additives include, for example, a polymerization initiator, a surfactant, a chiral agent, a polymerization inhibitor, an ultraviolet absorber, an antioxidant, a light stabilizer, an antifoaming agent, and a dichroic dye. A plurality of types of additives may be used in combination.

A known method may be used for applying the liquid crystal composition. The coating methods of the liquid crystal composition include, for example, a spin coating method, a bar coating method, an extrusion coating method, a direct gravure coating method, a reverse gravure coating method, and a die coating method. A solvent of the liquid crystal composition is removed by heating after coating.

The solvent of the liquid crystal composition is, for example, an organic solvent. The organic solvents include, for example, alcohols such as isopropyl alcohol; amides such as N,N-dimethylformamide; sulfoxides such as dimethyl sulfoxide; hydrocarbons such as benzene or hexane; esters such as methyl acetate, ethyl acetate, butyl acetate, or propylene glycol monoethyl ether acetate; ketones such as acetone, cyclohexanone or methyl ethyl ketone; or ethers such as tetrahydrofuran or 1,2-dimethoxyethane. Two or more types of the organic solvents may be used in combination. The liquid crystal layer 6 may be formed by a vapor deposition method or a vacuum injection method without using a solvent.

The liquid crystal composition to be used may have a positive wavelength dispersion of the Δn value after curing, and may have a negative wavelength dispersion.

The liquid crystal composition contains, for example, compounds represented by the following formulas (a-1) to (a-13) as a polymerizable compound.

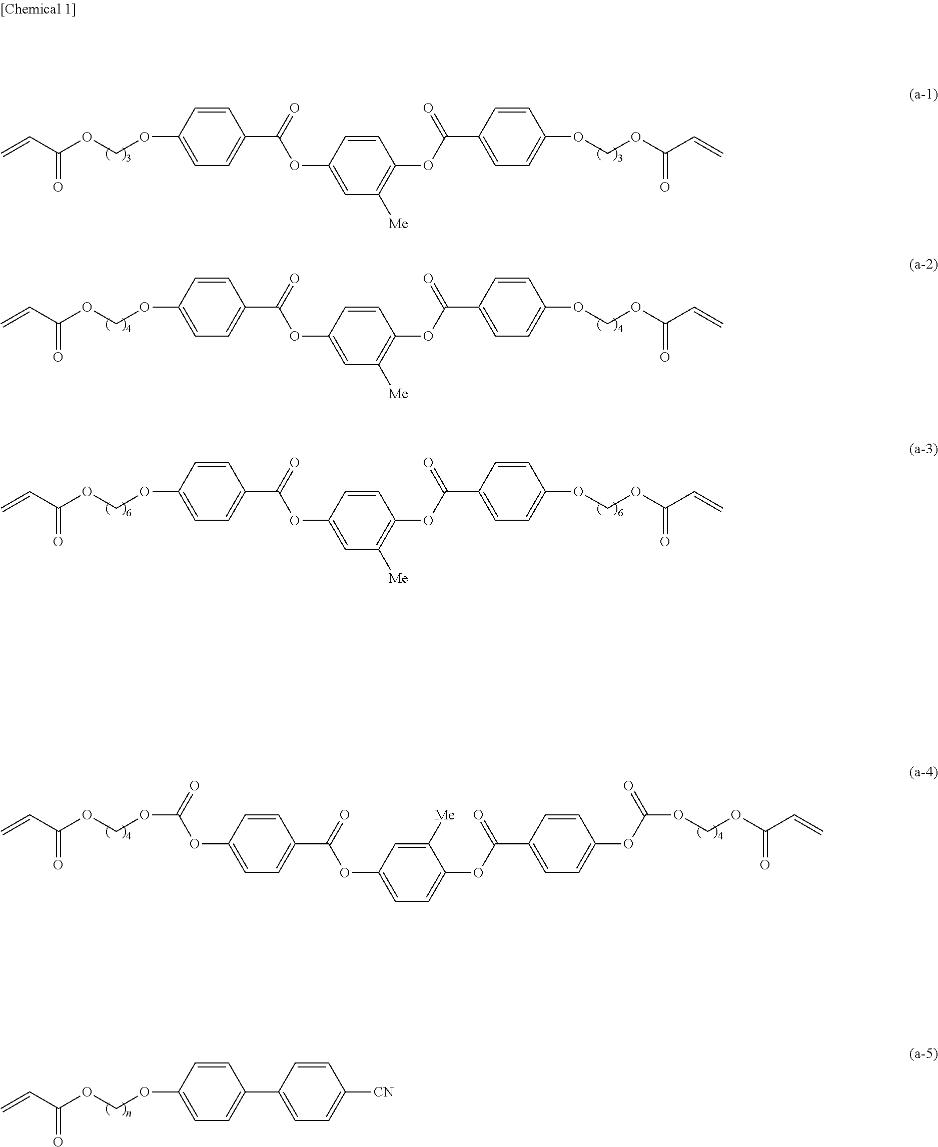

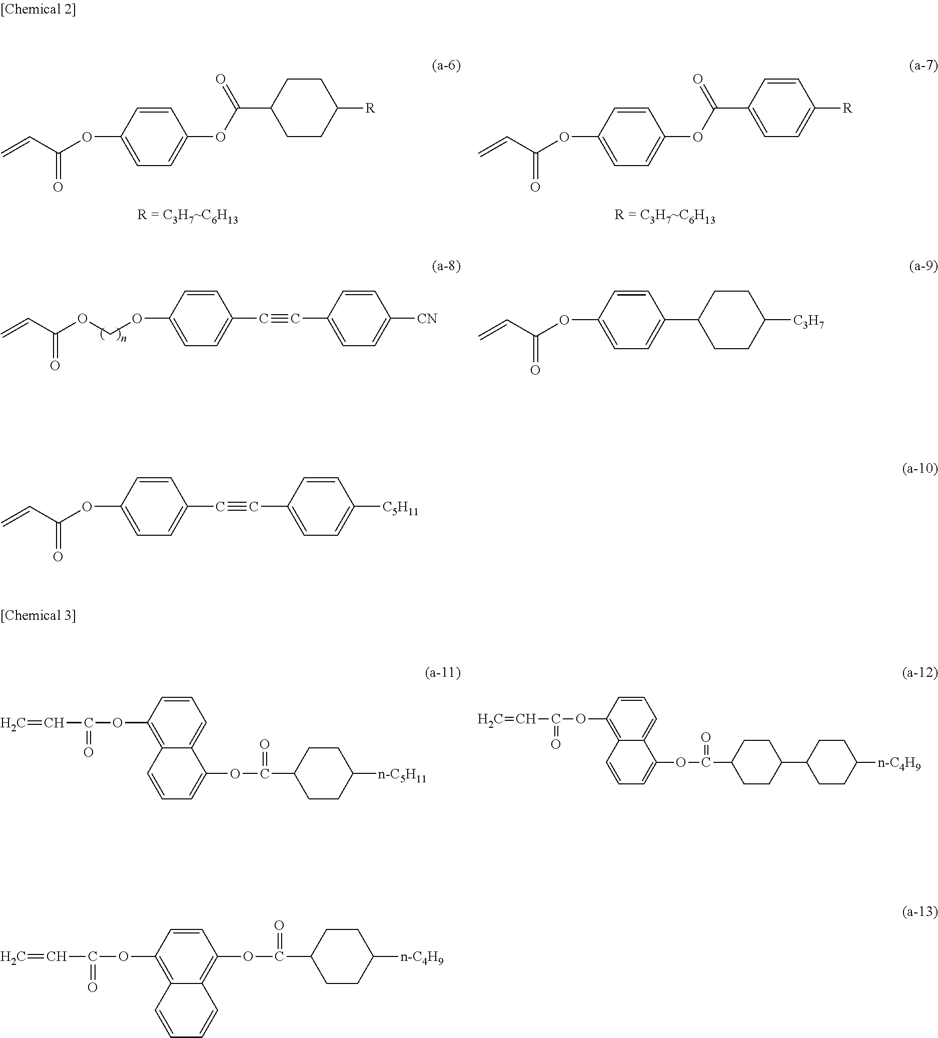

In the above formulas, (a-5) and (a-8), n is an integer of 2 to 6. In the above formulas (a-6) and (a-7), R is an alkyl group having 3 to 6 carbon atoms. In the above formulas (a-11), (a-12) and (a-13), n is an abbreviation for “normal”, and means a linear group.

The thickness T3 of the liquid crystal layer 6 (see FIG. 2B) is determined based on a wavelength of light, a retardation, and the difference Δn (Δn=ne-no). For example, when the wavelength of the light is 543 nm and the retardation is a ¼ wavelength, the retardation Rd is 136 nm. When the retardation Rd is 136 nm and the difference Δn is 0.1, the thickness T3 of the liquid crystal layer 6 is 1360 nm.

As described above, the thickness T3 of the liquid crystal layer 6 is determined based on the wavelengths of light, the retardation, and Δn. The thickness T3 is not particularly limited, and is, for example, 0.3 μm-30 μm, preferably 0.5 μm-20 μm, and more preferably 0.8 μm-10 μm. When the thickness T3 is 0.3 μm or more, a desired retardation is easily obtained. When the thickness T3 is 30 μm or less, liquid crystal molecules 61 are easily aligned.

The liquid crystal layer 6 is not limited to a ¼ wavelength plate and may be a ½ wavelength plate or the like. The liquid crystal layer 6 is not limited to a retardation layer that shifts a phase between two linearly polarized light components orthogonal to each other, and may be a compensation layer. The compensation layer, for example, corrects a retardation occurring at different viewing angles of a liquid crystal display, and improves a screen contrast within a predetermined viewing angle.

The thickness T3 of the liquid crystal layer 6 is measured in the direction normal to the surface 41 of the transparent substrate 4, at each point on the surface 41. When the alignment layer 5 has grooves 52, in the present specification, the thickness T3 of the liquid crystal layer 6 is a distance between the bottom of the grooves 52 and a surface of the liquid crystal layer 6 on the side opposite to the alignment layer 5.

The glass-transition temperature Tg_a of the liquid crystal layer 6 is, for example, 50° C.-200° C., and preferably 80° C.-180° C. When the glass-transition temperature Tg_a is within the above-described range, bending processability is good. The glass-transition temperature Tg_a of the liquid crystal layer 6 is measured by, for example, the TMA.

The thickness T4 of the retardation plate 3 is not particularly limited. The thickness T4 is, for example, 0.011 mm-0.301 mm, preferably 0.021 mm-0.101 mm, and more preferably 0.031 mm-0.091 mm. The thicknesses T4 of the retardation plate 3 are measured in the direction normal to the surface 41 of the transparent substrate 4, at each point.

The retardation plate 3 may be a wideband retardation plate further including a second liquid crystal layer (not shown) laminated on the liquid crystal layer 6. The number of the liquid crystal layers included in the wideband retardation plate may be two or more, and may be three or more. When viewed in the Z-axis direction, the plurality of liquid crystal layers have their slow axes oriented in directions different from each other. In the case where the retardation plate 3 includes the plurality of liquid crystal layers, the retardation plate 3 may include a plurality of alignment layers or may have a structure that repeats a set of a liquid crystal layer and an alignment layer. The plurality of alignment layers may have the same material and may have materials different from each other.

The retardation of the retardation plate 3 is not particularly limited. In the case where the retardation plate 3 is a ¼ wavelength plate, the retardation is, for example, 100 nm-180 nm, preferably 110 nm-170 nm, and more preferably 120 nm-160 nm. When the retardation plate 3 is a ½ wavelength plate, the retardation is, for example, 200 nm-280 nm, preferably 210 nm-270 nm, and more preferably 220 nm-260 nm.

### Second Embodiment

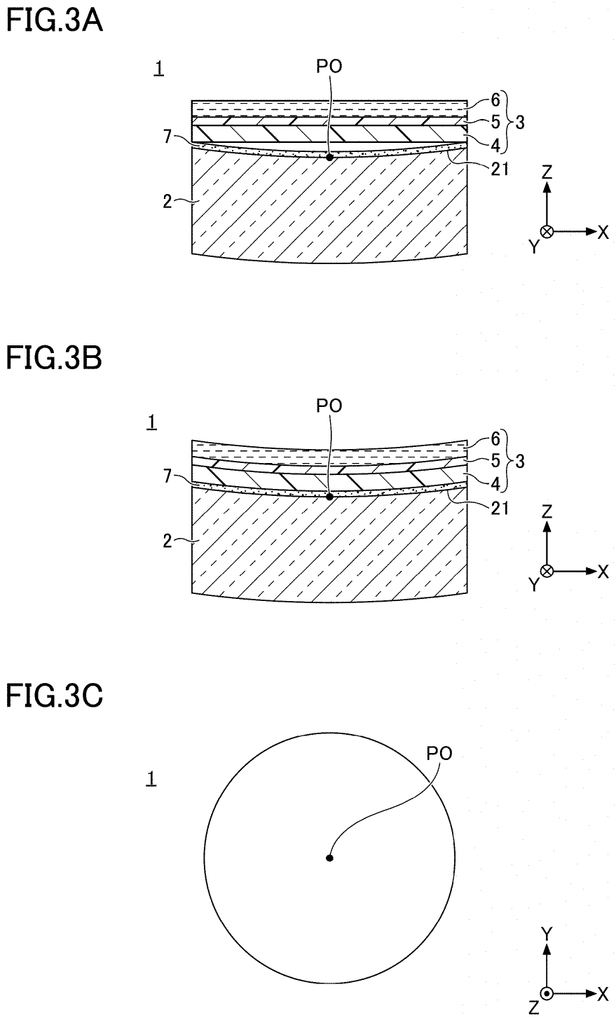

The optical element 1 according to a second embodiment will be described with reference to FIGS. 3A to 3C. Hereinafter, differences from the first embodiment will be mainly described. The optical element 1 preferably has a curved surface from a viewpoint of performance depending on an application of the optical element 1. For example, the optical element 1 includes a three-dimensional structure 2. The three-dimensional structure 2 may be a spherical lens or may be an aspherical lens. The three-dimensional structure 2 may be any one of a biconcave lens, a plano-concave lens, a concave meniscus lens, a biconvex lens, a plano-convex lens, and a convex meniscus lens.

The three-dimensional structure 2 has a curved surface 21. The curved surface 21 has a curvature radius of, for example, 10 mm-100 mm over the entire surface or a part thereof. The curvature radius of the curved surface 21 is preferably 20 mm-80 mm, and more preferably 50 mm-70 mm. The curved surface 21 is, for example, a concave surface as shown in FIGS. 3A and 3B. The concave surface is a curved surface in which a surface at a center of gravity P0 is concave from a periphery. In both the cross section perpendicular to the X-axis direction and the cross section perpendicular to the Y-axis direction, the center of gravity P0 of the concave surface is concave from the periphery of the concave surface. The X-axis direction, the Y-axis direction, and the Z-axis direction are perpendicular to each other. The Z-axis direction is a direction normal to the concave surface at the center of gravity P0. The XY plane is parallel to a tangential plane at the center of gravity P0 of the concave surface.

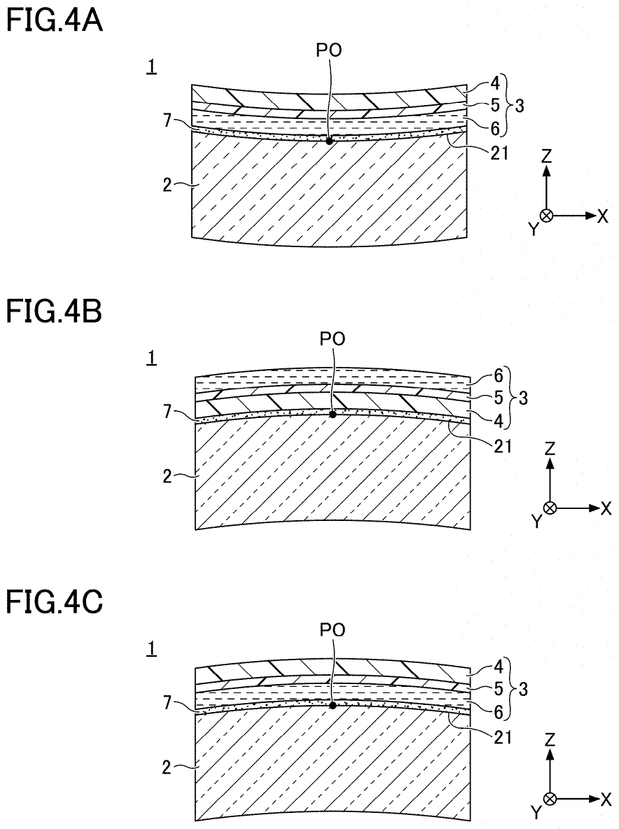

In the present embodiment, the curved surface 21 is a concave surface. However, the present disclosure is not limited to this, and the curved surface may be a convex surface as shown in FIGS. 4B and 4C. The convex surface is a curved surface in which the surface at the center of gravity P0 is protruded from the periphery. In both the cross section perpendicular to the X-axis direction and the cross section perpendicular to the Y-axis direction, the center of gravity P0 of the convex surface is protruded from the periphery of the convex surface.

The outer shape of the three-dimensional structure 2 is not limited to a circular shape illustrated in FIG. 3C, and may be, for example, an elliptical shape, or a polygonal shape (including a quadrangular shape).

The material of the three-dimensional structure 2 may be resin or may be glass. When the three-dimensional structure 2 is a resin lens, the resin of the resin lens is, for example, polycarbonate, polyimide, polyacrylate, or cyclic olefin. In the case where the three-dimensional structure is a glass lens, the glass of the glass lens is, for example, BK7 or synthetic quartz.

The optical element 1 includes a retardation plate 3. The retardation plate 3 is bent along the curved surface 21 of the three-dimensional structure 2. The retardation plate 3 includes, for example, a transparent substrate 4; an alignment layer 5 formed over the transparent substrate 4; and a liquid crystal layer 6 formed over the alignment layer 5.

The retardation plate 3 is, for example, a ¼ wavelength plate. The ¼ wavelength plate and a linearly polarizing plate (not illustrated) may be used in combination. The linearly polarizing plate may be disposed on the side opposite to the three-dimensional structure 2 with respect to the retardation plate 3, may be disposed between the retardation plate 3 and the three-dimensional structure 2, or may be disposed on the side opposite to the retardation plate 3 with respect to the three-dimensional structure 2.

The retardation plate 3 includes, for example, the transparent substrate 4, the alignment layer 5, and the liquid crystal layer 6 in this order from the three-dimensional structure 2 side as shown in FIG. 3B. As shown in FIGS. 4A and 4C, the retardation plate 3 may include the liquid crystal layer 6, the alignment layer 5, and the transparent substrate 4 in this order from the three-dimensional structure 2 side.

The thicknesses T1 (see FIG. 2A) of the transparent substrate 4 are measured in the direction normal to the curved surface 21 of the three-dimensional structure 2 at each point of the surface 21. The depth D (see FIG. 2A) of the groove 52 may be constant over the entire curved surface 21 of the three-dimensional structure 2, but may vary depending on the location as will be described later. The pitch p of the grooves 52 may be constant over the entire curved surface 21 of the three-dimensional structure 2, but may vary depending on the location.

Although the transparent substrate 4 is prepared separately from the three-dimensional structure 2 and is provided on the curved surface 21 of the three-dimensional structure 2 in the present embodiment, the transparent substrate 4 may be the three-dimensional structure 2. In the latter case, the alignment layer 5 is formed directly on the curved surface 21 of the three-dimensional structure 2.

Although not shown, the retardation plate 3 may be a wideband retardation plate further including a second liquid crystal layer laminated on the liquid crystal layer 6. The number of the liquid crystal layers included in the wideband retardation plate may be two or more, and may be three or more. When viewed in the Z-axis direction, the plurality of liquid crystal layers have slow axes orientated in directions different from each other.

The wideband retardation plate is formed by, for example, alternately laminating the alignment layers 5 and the liquid crystal layers 6. The alignment layer 5 and the liquid crystal layer 6 are laminated in this order from the three-dimensional structure 2 side. Alternatively, the wideband retardation plate may be formed by bonding the liquid crystal layer formed over a transparent substrate different from the three-dimensional structure 2 and the liquid crystal layer formed over the three-dimensional structure 2 to each other.

The retardation plate 3 is bent and bonded to the three-dimensional structure 2. The bonding layer 7 is formed of, for example, optical clear adhesive (OCA), liquid adhesive (OSA), polyvinyl butyral (PVB), ethylene vinyl acetate (EVA), cycloolefin polymer (COP) or thermoplastic polyurethane (TPU).

The retardation of the bonding layer 7 is, for example, 5 nm or less, and preferably 3 nm or less. The retardation of the bonding layer 7 is preferably as small as possible from the viewpoint of reducing variation in color tone, and may be zero. The retardation of the bonding layer 7 is measured by, for example, a parallel Nicol rotation method.

The glass-transition temperature of the bonding layer 7 is, for example, −60° C.-+100° C., and preferably −40° C.-+50° C. When the glass-transition temperature of the bonding layer 7 is within the above-described range, both bending processability and shape followability can be achieved. The glass-transition temperature of the bonding layer 7 is measured by, for example, the TMA.

The thickness of the bonding layer 7 is, for example, 0.001 mm-0.1 mm, and preferably 0.005 mm-0.05 mm. When the thickness of the bonding layer 7 is within the above-described range, both bending processability and shape followability can be achieved. The thickness of the bonding layer 7 is measured in the direction normal to the curved surface 21 of the three-dimensional structure 2 at each point on the surface 21.

The retardation plate 3 and the three-dimensional structure 2 are bonded while being heated. The heating temperature is set based on the glass-transition temperature Tgf of the transparent substrate 4. The heating temperature is set within a range of, for example, Tgf −10° C. or more and Tgf +30° C. or less, and preferably within a range of Tgf −10° C. or more and Tgf+20° C. or less. The retardation plate 3 and the three-dimensional structure 2 may be bonded in a vacuum.

Alternatively, the three-dimensional structure 2 and the retardation plate 3 may be integrated by disposing the retardation plate 3 in a mold for injection molding, bending the retardation plate 3, and performing injection molding for the three-dimensional structure 2. In the case where the three-dimensional structure 2 and the retardation plate 3 are integrated by in-mold molding, the bonding layer 7 is unnecessary.

### Third Embodiment

Next, an optical element 1 according to a third embodiment and the like will be described. Hereinafter, differences from the second embodiment will be mainly described.

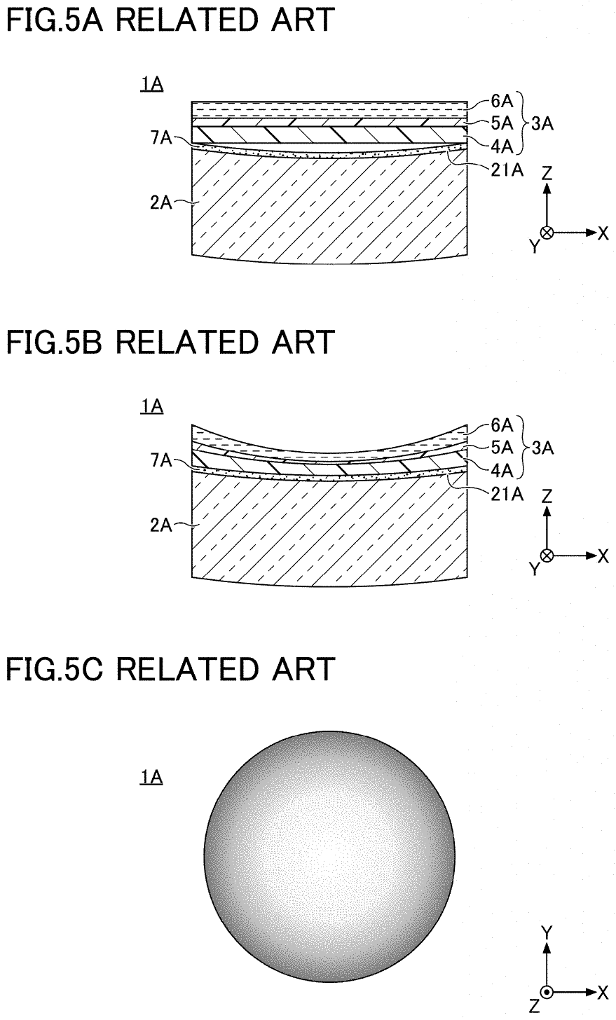

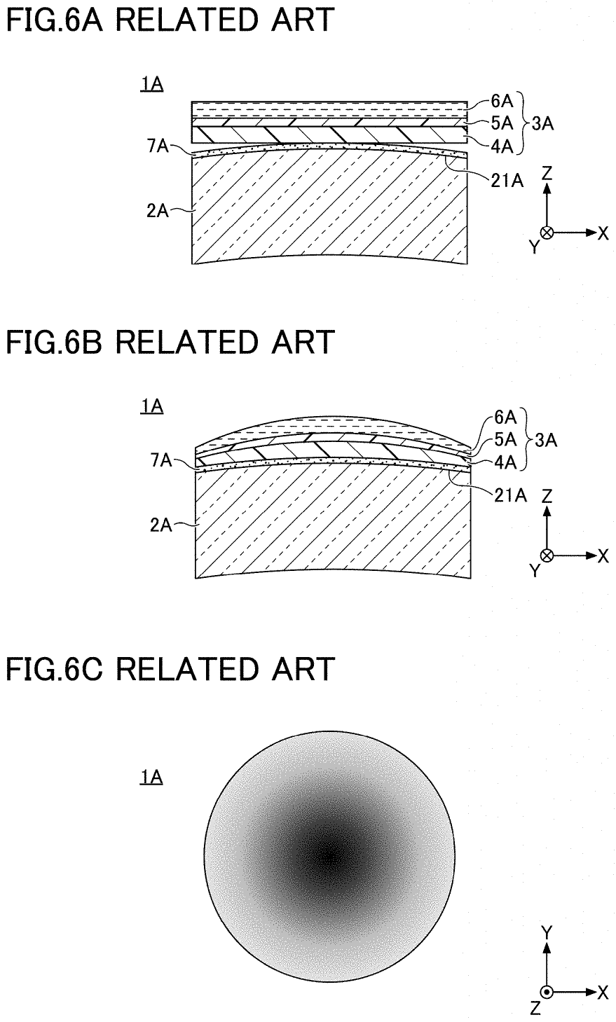

First, an optical element 1A according to a reference embodiment will be described with reference to FIGS. 5A to 6C. In FIG. 5C and FIG. 6C, the magnitude of the retardation Rd is expressed in gray scale. As the density becomes closer to black from white, the magnitude of the retardation Rd of the optical element 1A increases.

The optical element 1A according to the reference embodiment includes a three-dimensional structure 2A and a retardation plate 3A. The retardation plate 3A includes a transparent substrate 4A, an alignment layer 5A, and a liquid crystal layer 6A. The three-dimensional structure 2A and the retardation plate 3A are bonded to each other via, for example, a bonding layer 7A.

In the bending process for the retardation plate 3A, the extension rate at the periphery of the retardation plate 3A is different from the extension rate at the center of the retardation plate 3A. As a result, the thickness of the retardation plate 3A and the thickness of the liquid crystal layer 6A change concentrically. Therefore, the retardation Rd is concentrically shifted and the color tone is concentrically shifted. The extension rate (%) is obtained from the equation “(A1-A2)/A1×100”, where the size before bending is denoted by A1 and the size after the bending is denoted by A2.

For example, in the case where the curved surface 21A of the three-dimensional structure 2A is a concave surface as shown in FIG. 5A, when the retardation plate 3A is subjected to the bending process as shown in FIG. 5B, the retardation plate 3A becomes continuously thinner from the periphery toward the center of the retardation plate 3A. This is because the periphery of the retardation plate 3C comes into contact with the curved surface 21A at a timing different from the timing when the center of the retardation plate 3A comes into contact with the curved surface 21A. The center of the retardation plate 3A comes into contact with the curved surface 21A after the periphery comes into contact with the curved surface 21A.

Therefore, as shown in FIG. 5B, the liquid crystal layer 6A becomes continuously thinner from the periphery to the center of the liquid crystal layer 6A. As a result, the retardation Rd continuously decreases from the periphery to the center of the liquid crystal layer 6A as shown in FIG. 5C. Therefore, the color tone is shifted concentrically.

Further, in the case where the curved surface 21A of the three-dimensional structure 2A is a convex surface as shown in FIG. 6A, when the retardation plate 3A is subjected to the bending process as shown in FIG. 6B, the retardation plate 3A becomes continuously thinner from the center to the periphery of the retardation plate 3A. This is because the periphery of the retardation plate 3A comes into contact with the curved surface 21A at a timing different from the timing when the center of the retardation plate 3A comes into contact with the curved surface 21A. The periphery of the retardation plate 3A comes into contact with the curved surface 21A after the center of the retardation plate 3A comes into contact with the curved surface 21A.

Therefore, as shown in FIG. 6B, the liquid crystal layer 6A becomes thinner continuously from the center to the periphery of the liquid crystal layer 6A. As a result, the retardation Rd continuously decreases from the center to the periphery of the liquid crystal layer 6C as shown in FIG. 6C. Therefore, the color tone is shifted concentrically.

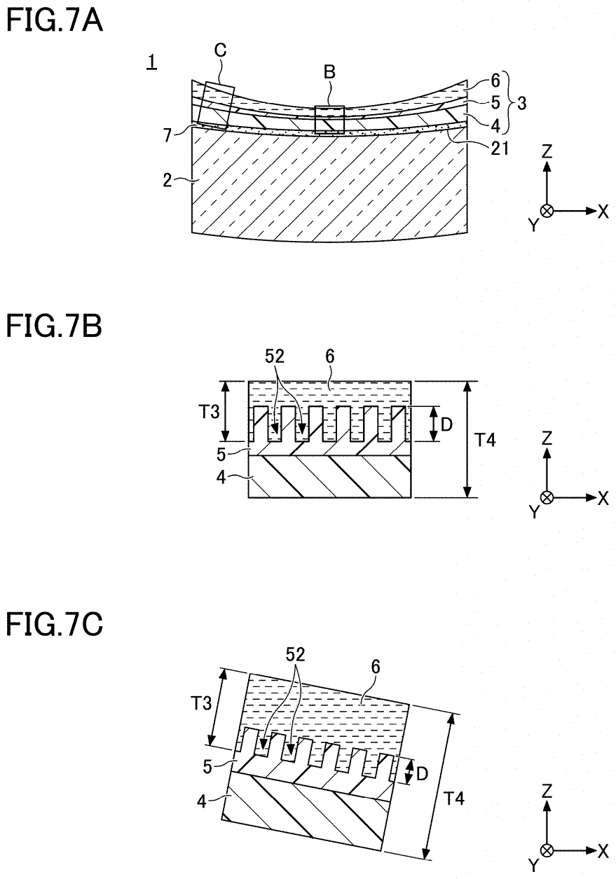

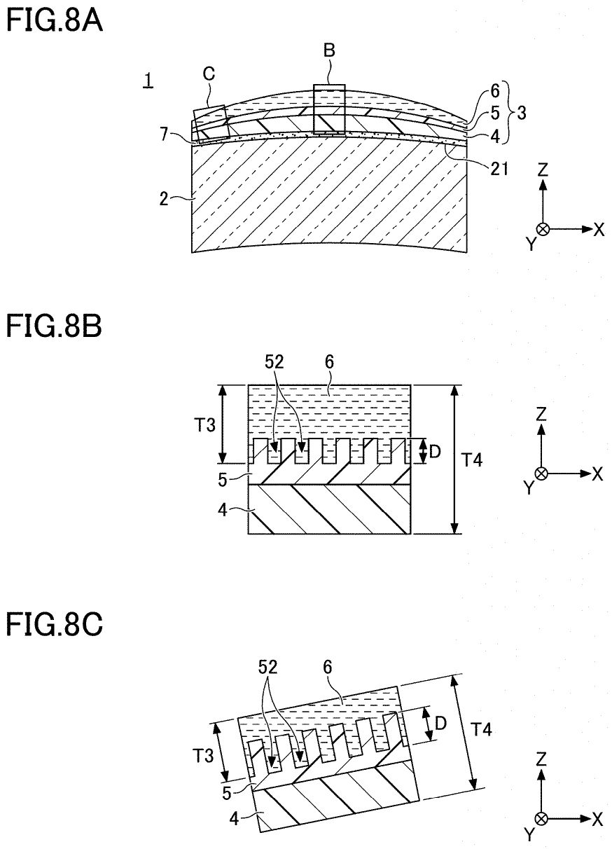

As shown in FIGS. 7A to 8C, the optical element 1 according to the present embodiment includes a three-dimensional structure 2 and a retardation plate 3. The retardation plate 3 includes a transparent substrate 4, an alignment layer 5, and a liquid crystal layer 6. The three-dimensional structure 2 and the retardation plate 3 are bonded to each other via, for example, a bonding layer 7. The alignment layer 5 has a plurality of grooves 52 parallel to each other on a surface in contact with the liquid crystal layer 6.

When the retardation plate 3 is subjected to the bending process, the extension rate of the retardation plate 3 at the periphery of the retardation plate 3 is different from the extension rate at the center of the retardation plate 3. As a result, the thickness T4 of the retardation plate 3 and the thickness T3 of the liquid crystal layer 6 at the center of the retardation plate are different from the thickness T3 and the thickness T4 at the periphery of the retardation plate 3, respectively, after the bending process of the retardation plate 3, in the same manner as in the reference embodiment.

For example, in the case where the curved surface 21 of the three-dimensional structure 2 is a concave surface as shown in FIG. 7A, when the retardation plate 3 is subjected to the bending process, the thickness T4 of the retardation plate 3 and the thickness T3 of the liquid crystal layer 6 continuously decrease from the periphery to the center of the retardation plate 3 as described in the reference embodiment.

When the curved surface 21 of the three-dimensional structure 2 is a concave surface, the extension rate of the retardation plate 3 is as follows. The extension rate of the retardation plate 3 at the periphery of the retardation plate 3 is, for example, 0.1%-20%, and preferably 1%-15%. The extension rate of the retardation plate 3 at the center of the retardation plate 3 is, for example, 0.5%-40%, and preferably 1%-20%.

In the case where the curved surface 21 of the three-dimensional structure 2 is a convex surface as shown in FIG. 8A, when the retardation plate 3 is subjected to the bending process, the thickness T4 of the retardation plate 3 and the thickness T3 of the liquid crystal layer 6 continuously decrease from the center to the periphery of the retardation plate 3, as described in the reference embodiment.

When the curved surface 21 of the three-dimensional structure 2 is a convex surface, the extension rate of the retardation plate 3 is as follows. The extension rate of the retardation plate 3 at the center of the retardation plate 3 is, for example, 0.1%-20%, and preferably 1%-15%. The extension rate of the retardation plate 3 at the periphery of the retardation plate 3 is, for example, 0.5%-40%, and preferably 1%-20%.

Therefore, in the optical element 1 of the present embodiment and the like, the depth D of the groove 52 at the portion where the thickness T4 of the retardation plate 3 is the thinnest is deeper than the depth D of the groove 52 at the portion where the thickness T4 of the retardation plate 3 is the thickest. The depth D of the groove 52 is adjusted by, for example, a concave-convex pattern of a mold used in an imprint method. The depth D of the groove 52 can also be adjusted by partially ashing the surface 51 of the alignment layer 5.

As the depth D of the groove 52 is deeper, the alignment restricting force is greater and Δn is greater. The increase in the retardation Rd due to the increase in Δn can complement the decrease in the retardation Rd due to the decrease in d, and the variation in the retardation Rd can be suppressed.

For example, when the curved surface 21 of the three-dimensional structure 2 is a concave surface as shown in FIG. 7A, the depth D of the groove 52 at the center of the retardation plate 3 is deeper than the depth D of the groove 52 at the periphery of the retardation plate 3 which is apparent when FIG. 7B is compared with FIG. 7C. The depth D of the groove 52 increases continuously or stepwise from the periphery to the center of the retardation plate 3. Thus, the concentric shift of the retardation Rd can be suppressed, and thereby the concentric shift of the color tone can be suppressed.

When the curved surface 21 of the three-dimensional structure 2 is a convex surface as shown in FIG. 8A, the depth D of the groove 52 at the periphery of the retardation plate 3 is deeper than the depth D of the groove 52 at the center of the retardation plate 3 as is apparent from comparison between FIG. 8B and FIG. 8C. The depth D of the groove 52 increases continuously or stepwise from the center to the periphery of the retardation plate 3. Therefore, it is possible to suppress the concentric shift of the retardation Rd, and thereby the concentric shift of the color tone can be suppressed.

### Examples

Hereinafter, experimental data will be described.

### <Materials>

Materials prepared for Examples are as follows:

Monomer B1: perfluorohexylethyl methacrylate, product name “C6FMA” by AGC Inc.;

Monomer B2: dimethylol-tricyclodecane diacrylate, product name “NK Ester A-DCP” by Shin-Nakamura Chemical Co., Ltd.;

Monomer B3: 1,6-hexanediol diacrylate, product name “NK Ester A-HD-N” by Shin-Nakamura Chemical Co., Ltd.;

Monomer B4: product name “DPHA” manufactured by Shin-Nakamura Chemical Co., Ltd.;

Surfactant C1: product name “Surflon S-651” by AGC Seimi Chemical Co., Ltd.;

Surfactant C2: product name “Ftergent 710FL” by Neos Co., Ltd.;

Surfactant C3: product name “BYK327” by BYK Chemie GmbH;

Liquid crystal D1: product name “LC 242” by BASF Japan Ltd.;

Photopolymerization initiator E1: product name “IRGACURE907” by Ciba Specialty Chemicals Ltd.;

Solvent F1: methyl ethyl ketone; and

Transparent substrate G1: TAC film, product name “ZRD40SL” by Fujifilm Corporation (thickness was 40 μm).

### <Photocurable Compositions A1-A13>

Photocurable compositions A1-A13 were prepared with blending amounts shown in TABLE 1.

TABLE 1

| | Blending amount [g] | | | | | | | | | Before curing | | After curing |
|---|---|---|---|---|---|---|---|---|---|---|---|---|
| Photo | | | | | | | | Photo | | | C1-C3 | Fluorine |
| curable | Monomer | | | | Surfactant | | | polymerization | | B1 | total | concentration |
| composition | B | | | | C | | | initiator | Total | concentration | concentration | FC |
| A | B1 | B2 | B3 | B4 | C1 | C2 | C3 | E1 | [g] | [wt %] | [wt %] | [at %] |
| A1 | 0 | 40 | 40 | 20 | 0 | 0 | 0 | 3 | 103 | 0 | 0.00 | 0 |
| A2 | 5 | 40 | 35 | 20 | 0 | 0 | 0 | 3 | 103 | 5 | 0.00 | 8 |
| A3 | 10 | 35 | 35 | 20 | 0 | 0 | 0 | 3 | 103 | 10 | 0.00 | 11 |
| A4 | 20 | 30 | 30 | 20 | 0 | 0 | 0 | 3 | 103 | 19 | 0.00 | 13 |
| A5 | 0 | 40 | 40 | 20 | 0.5 | 0 | 0 | 3 | 103.5 | 0 | 0.48 | 10 |
| A6 | 0 | 40 | 40 | 20 | 1 | 0 | 0 | 3 | 104 | 0 | 0.96 | 14 |
| A7 | 0 | 40 | 40 | 20 | 0 | 1 | 0 | 3 | 104 | 0 | 0.96 | 19 |
| A8 | 0 | 40 | 40 | 20 | 0 | 0 | 1 | 3 | 104 | 0 | 0.96 | 0 |
| A8 | 10 | 35 | 35 | 20 | 1 | 0 | 0 | 3 | 104 | 10 | 0.96 | 14 |
| A10 | 20 | 30 | 30 | 20 | 1 | 0 | 0 | 3 | 104 | 19 | 0.96 | 17 |
| A11 | 50 | 10 | 30 | 10 | 1 | 0 | 0 | 3 | 104 | 48 | 0.96 | 20 |
| A12 | 0 | 40 | 40 | 20 | 5 | 0 | 0 | 3 | 108 | 0 | 4.63 | |
| A13 | 60 | 10 | 30 | 10 | 0 | 0 | 0 | 3 | 113 | 53 | 0.00 | |

Each of the photocurable compositions A1 to A13 was a solventless type composition, which does not contain solvent. The photocurable compositions A12 and A13 were cloudy, and did not readily transmit light. The photocurable compositions A12 and A13 were therefore unsuitable for use as the alignment layers.

### <Liquid Crystal Composition L1>

A liquid crystal composition L1 was prepared by mixing the liquid crystal D1 of 100 g and the photopolymerization initiator E1 of 3.0 g, and diluting the obtained mixture with the solvent F1 to the solid concentration of 25 mass %.

### <Liquid Crystal Composition L2>

A liquid crystal composition L2 was prepared by mixing the liquid crystal D1 of 100 g, the surfactant C1 of 0.4 g, and the photopolymerization initiator E1 of 3.0 g, and diluting the obtained mixture with the solvent F1 to the solid concentration of 25 mass %.

### <Molds M1 to M7>

Molds M1 to M7 were prepared as follows:

A mold M1 was prepared by forming a concave-convex pattern having a groove pitch of 90 nm and a groove depth of 130 nm on a silicon wafer by using a photolithography method;

A mold M2 was prepared by forming a concave-convex pattern having a groove pitch of 140 nm and a groove depth of 130 nm on a silicon wafer by using a photolithography method;

A mold M3 was reflective holographic gratings with 3600 GPM (grooves per millimeter) for VIS (visible light) with the dimension of 50 mm by Edmund Optics Inc.;

A mold M4 was reflective holographic gratings with 2400 GPM for VIS with the dimension of 50 mm by Edmund Optics Inc.;

A mold M5 was reflective holographic gratings with 1800 GPM for VIS with the dimension of 50 mm by Edmund Optics Inc.;

A mold M6 was reflective holographic gratings with 1200 GPM for VIS with the dimension of 50 mm by Edmund Optics Inc.; and

A mold M7 was blazed gratings with 900 GPM for 500 nm with the dimension of 25 mm by Edmund Optics Inc.

### <Mold M8>

A mold M8 was prepared by the following procedure. First, the photocurable composition A1 was interposed between the mold M1 and a PET film (product name “COSMOSHINE A4300” by Toyobo Co., Ltd. (thickness was 250 μm)), and the photocurable composition A1 was irradiated with ultraviolet rays with an intensity of 1000 mJ/cm² through the PET film while maintaining a gap therebetween to be 5 μm to cure the photocurable composition A1. Thereafter, the mold M1 was peeled off to prepare the mold M1-2. Thus, the concave-convex pattern of the mold M1-2 was obtained by reversing the concave-convex pattern of the mold M1.

The mold M1-2 was subjected to an ashing process for 5 minutes under vacuum with an oxygen supply at 200 ml/min and a power of 400 W. Thereafter, the photocurable composition A1 was interposed between the mold M1-2 and a PET film (product name “COSMOSHINE A4300” by Toyobo Co., Ltd. (thickness was 250 μm)), and the photocurable composition A1 was irradiated with ultraviolet rays with an intensity of 1000 mJ/cm² through the PET film while maintaining a gap therebetween to be 5 μm to cure the photocurable composition A1. Thereafter, the mold M1-2 was peeled off to produce the mold M8. The concave-convex pattern of the mold M8 was obtained by reversing the concave-convex pattern of the mold M1-2. The depth of the groove in the mold M8 was 25 nm.

### <Mold M9>

A mold M9 was prepared in the same manner as the mold M8 except that the mold M2 was used instead of the mold M1 and the ashing was performed for 8 minutes. The depth of the groove in the mold M9 was 40 nm.

### <Mold M10>

The mold M10 was prepared in the same manner as the mold M8 except that the mold M2 was used instead of the mold M1 and the ashing was performed for 12 minutes. The depth of the groove in the mold M10 was 15 nm.

### <Optical Element>

In Examples 1-49 described below, optical elements were prepared using the above-described photocurable compositions A1-A11, the above-described molds M1-M10, and the above-described liquid crystal compositions L1 and L2. Examples 2-12, 14, 16, 18, 24, 26, 28, 30, 32, 34, 36, 38-39, 41, 43, 45-46 and 48 described below are practical examples, and Examples 1, 13, 15, 17, 19-23, 25, 27, 29, 31, 33, 35, 37, 40, 42, 44, 47-49 described below are comparative examples.

### Example 1

The alignment layer was prepared by the following procedure. First, the photocurable composition A1 was interposed between the mold M2 and the transparent substrate G1, and the photocurable composition A1 was irradiated with ultraviolet rays with an intensity of 1000 mJ/cm² through the transparent substrate G1 in a state where a gap therebetween was maintained to be 5 μm to cure the photocurable composition A1. Thereafter, the mold M2 was peeled off to produce a laminate consisting of the alignment layer and the transparent substrate G1, concave-convex pattern being formed over the alignment layer.

The liquid crystal layer was prepared by the following procedure. First, the above-described liquid crystal composition L1 was applied to the surface of the alignment layer on which concave-convex pattern was formed by a spin coating method, and dried at 90° C. for 5 minutes, to form a liquid film having a thickness of 1 μm. The liquid film was irradiated with ultraviolet rays with an intensity of 1000 mJ/cm² under a nitrogen gas atmosphere, to cure the liquid crystal composition L1. Thus, an optical element according to Example 1 including the liquid crystal layer, the alignment layer, and the transparent substrate was obtained.

### Example 2

An optical element according to Example 2 was prepared in the same manner as in Example 1, except that the photocurable composition A2 was used instead of the photocurable composition A1.

### Example 3

An optical element according to Example 3 was prepared in the same manner as in Example 1, except that the photocurable composition A3 was used instead of the photocurable composition A1.

### Example 4

An optical element according to Example 4 was prepared in the same manner as in Example 1, except that the photocurable composition A4 was used instead of the photocurable composition A1.

### Example 5

An optical element according to Example 5 was prepared in the same manner as in Example 1, except that the photocurable composition A5 was used instead of the photocurable composition A1.

### Example 6

An optical element according to Example 6 was prepared in the same manner as in Example 1, except that the photocurable composition A6 was used instead of the photocurable composition A1.

### Example 7

An optical element according to Example 7 was prepared in the same manner as in Example 1, except that the photocurable composition A7 was used instead of the photocurable composition A1.

### Example 8

An optical element according to Example 8 was prepared in the same manner as in Example 1, except that the photocurable composition A8 was used instead of the photocurable composition A1.

### Example 9

An optical element according to Example 9 was prepared in the same manner as in Example 1, except that the photocurable composition A9 was used instead of the photocurable composition A1.

### Example 10

An optical element according to Example 10 was prepared in the same manner as in Example 1, except that the photocurable composition A10 was used instead of the photocurable composition A1.

### Example 11

An optical element according to Example 11 was prepared in the same manner as in Example 1, except that the photocurable composition A11 was used instead of the photocurable composition A1.

### Example 12

An optical element according to Example 12 was prepared in the same manner as in Example 1, except that the photocurable composition A9 was used instead of the photocurable composition A1, and the mold M1 was used instead of the mold M2.

### Example 13

An optical element according to Example 13 was prepared in the same manner as in Example 1, except that the mold M1 was used instead of the mold M2.

### Example 14

An optical element according to Example 14 was prepared in the same manner as in Example 1, except that the photocurable composition A9 was used instead of the photocurable composition A1, and the mold M3 was used instead of the mold M2.

### Example 15

An optical element according to example 15 was prepared in the same manner as in Example 1, except that the mold M3 was used instead of the mold M2.

### Example 16

An optical element according to Example 16 was prepared in the same manner as in Example 1, except that the photocurable composition A9 was used instead of the photocurable composition A1, and the mold M4 was used instead of the mold M2.

### Example 17

An optical element according to Example 17 was prepared in the same manner as in Example 1, except that the mold M4 was used instead of the mold M2.

### Example 18

An optical element according to Example 18 was prepared in the same manner as in Example 1, except that the photocurable composition A9 was used instead of the photocurable composition A1, and the mold M5 was used instead of the mold M2.

### Example 19

An optical element according to Example 19 was prepared in the same manner as in Example 1, except that the mold M5 was used instead of the mold M2.

### Example 20

An optical element according to Example 20 was prepared in the same manner as in Example 1, except that the photocurable composition A9 was used instead of the photocurable composition A1, and the mold M6 was used instead of the mold M2.

### Example 21

An optical element according to Example 21 was prepared in the same manner as in Example 1, except that the mold M6 was used instead of the mold M2.

### Example 22

An optical element according to Example 22 was prepared in the same manner as in Example 1, except that the photocurable composition A9 was used instead of the photocurable composition A1, and the mold M7 was used instead of the mold M2.

### Example 23

An optical element according to Example 23 was prepared in the same manner as in Example 1, except that the mold M7 was used instead of the mold M2.

### Example 24

An optical element according to Example 24 was prepared in the same manner as in Example 1, except that the photocurable composition A9 was used instead of the photocurable composition A1, and the mold M8 was used instead of the mold M2.

### Example 25

An optical element according to Example 25 was prepared in the same manner as in Example 1, except that the mold M8 was used instead of the mold M2.

### Example 26

An optical element according to Example 26 was prepared in the same manner as in Example 1, except that the photocurable composition A1 was used instead of the photocurable composition A9, and the mold M9 was used instead of the mold M2.

### Example 27

An optical element according to Example 27 was prepared in the same manner as in Example 1, except that the mold M9 was used instead of the mold M2.

### Example 28

An optical element according to Example 28 was prepared in the same manner as in Example 1, except that the photocurable composition A9 was used instead of the photocurable composition A1, and the mold M10 was used instead of the mold M2.

### Example 29

An optical element according to Example 29 was prepared in the same manner as in Example 1, except that the mold M10 was used instead of the mold M2.

### Example 30

An optical element according to Example 30 was prepared in the same manner as in Example 1, except that the photocurable composition A10 was used instead of the photocurable composition A1, the liquid crystal composition L2 was used instead of the liquid crystal composition L1, and the mold M1 was used instead of the mold M2.

### Example 31

An optical element according to Example 31 was prepared in the same manner as in Example 1, except that the liquid crystal composition L2 was used instead of the liquid crystal composition L1 and the mold M1 was used instead of the mold M2.

### Example 32

An optical element according to Example 32 was prepared in the same manner as in Example 1, except that the photocurable composition A10 was used instead of the photocurable composition A1 and the liquid crystal composition L2 was used instead of the liquid crystal composition L1.

### Example 33

An optical element according to Example 33 was prepared in the same manner as in Example 1, except that the liquid crystal composition L2 was used instead of the liquid crystal composition L1.

### Example 34

An optical element according to Example 34 was prepared in the same manner as in Example 1, except that the photocurable composition A10 was used instead of the photocurable composition A1, the liquid crystal composition L2 was used instead of the liquid crystal composition L1, and the mold M5 was used instead of the mold M2.

### Example 35

An optical element according to Example 35 was prepared in the same manner as in Example 1, except that the liquid crystal composition L2 was used instead of the liquid crystal composition L1 and the mold M5 was used instead of the mold M2.

### Example 36

An optical element according to Example 36 was prepared in the same manner as in Example 1, except that the photocurable composition A9 was used instead of the photocurable composition A1, the thickness T3 of the liquid crystal layer was set to 2 μm, and the mold M1 was used instead of the mold M2.

### Example 37

An optical element according to Example 37 was prepared in the same manner as in Example 1, except that the thickness T3 of the liquid crystal layer was set to 2 μm, and the mold M1 was used instead of the mold M2.

### Example 38

An optical element according to Example 38 was prepared in the same manner as in Example 1, except that the photocurable composition A10 was used instead of the photocurable composition A1, and the thickness T3 of the liquid crystal layer was set to 2 μm.

### Example 39

An optical element according to Example 39 was prepared in the same manner as in Example 1, except that the photocurable composition A9 was used instead of the photocurable composition A1, and the thickness T3 of the liquid crystal layer was set to 2 μm.

### Example 40

An optical element according to Example 40 was prepared in the same manner as in Example 1, except that the thickness T3 of the liquid crystal layer was set to 2 μm.

### Example 41

An optical element according to Example 41 was prepared in the same manner as in Example 1, except that the photocurable composition A9 was used instead of the photocurable composition A1, the thickness T3 of the liquid crystal layer was set to 2 μm, and the mold M5 was used instead of the mold M2.

### Example 42

An optical element according to Example 42 was prepared in the same manner as in Example 1, except that the thickness T3 of the liquid crystal layer was set to 2 μm, and the mold M5 was used instead of the mold M2.

### Example 43

An optical element according to Example 43 was prepared in the same manner as in Example 1, except that the photocurable composition A9 was used instead of the photocurable composition A1, the liquid crystal composition L2 was used instead of the liquid crystal composition L1, the thickness T3 of the liquid crystal layer was set to 2 μm, and the mold M1 was used instead of the mold M2.

### Example 44

An optical element according to Example 44 was prepared in the same manner as in Example 1, except that the liquid crystal composition L2 was used instead of the liquid crystal composition L1, the thickness T3 of the liquid crystal layer was set to 2 μm, and the mold M1 was used instead of the mold M2.

### Example 45

An optical element according to Example 45 was prepared in the same manner as in Example 1, except that the photocurable composition A10 was used instead of the photocurable composition A1, the liquid crystal composition L2 was used instead of the liquid crystal composition L1, and the thickness T3 of the liquid crystal layer was set to 2 μm.

### Example 46

An optical element according to Example 46 was prepared in the same manner as in Example 1, except that the photocurable composition A9 was used instead of the photocurable composition A1, the liquid crystal composition L2 was used instead of the liquid crystal composition L1, and the thickness T3 of the liquid crystal layer was set to 2 μm.

### Example 47

An optical element according to Example 47 was prepared in the same manner as in Example 1, except that the liquid crystal composition L2 was used instead of the liquid crystal composition L1, and the thickness T3 of the liquid crystal layer was set to 2 μm.

### Example 48

An optical element according to Example 48 was prepared in the same manner as in Example 1, except that the photocurable composition A9 was used instead of the photocurable composition A1, the liquid crystal composition L2 was used instead of the liquid crystal composition L1, the thickness T3 of the liquid crystal layer was set to 2 μm, and the mold M5 was used instead of the mold M2.

### Example 49

An optical element according to Example 49 was prepared in the same manner as in Example 1, except that the liquid crystal composition L2 was used instead of the liquid crystal composition L1, the thickness T3 of the liquid crystal layer was set to 2 μm, and the mold M5 was used instead of the mold M2.

### <Depth D and Pitch p of Grooves in Alignment Layer>

The depth D and the pitch p of the grooves of the alignment layers prepared in Examples 1 to 49 were measured by cross-sectional SEM observation. More specifically, each of the depth D and the pitch p was obtained by averaging measured values at five points.

### <Fluorine Concentration FC of Surface of Alignment Layer>

The fluorine concentration FC of the surface of the alignment layer was measured by X-ray photoelectron spectroscopy (XPS). Since the detection depth in XPS was about 5 nm, which was very shallow, a measured value of XPS was adopted as the fluorine concentration FC. The measurement conditions of XPS were as follows.

Instrument used: product name “K-Alpha XPS system” by Thermo Fisher Scientific Inc.;

Size of analysis: 00.4 mm;

Input area:
Survey scan: 0 eV to 1,350 eV;
Narrow scan: F1s, C1s, O1s, and N1s;

Pass energy:
Survey scan: 1 eV; and
Narrow scan: 0.1 eV.

### <Retardation of Optical Element>

The retardation Rd of the optical elements prepared in Examples 1 to 49 was measured using a measurement apparatus “Photal” by Otsuka Electronics Co., Ltd. Note that Rd is a retardation of light with a wavelength of 589 nm. The retardation Rd was obtained by averaging measured values at five points in a plane.

### <Presence or Absence of Diffracted Light>

It was examined whether diffracted light was present by irradiating each of the optical elements prepared in Examples 1 to 49 with white LED light from the transparent substrate side and observing from the liquid crystal layer side.

### SUMMARY

TABLE 2 shows results of evaluation of Examples 1 to 11. In TABLE 2, “Excellent” means that the effect of improving the retardation Rd was observed, and “Poor” means that the effect of improving the retardation Rd was not observed. In TABLES 3 to 7, “Excellent” and “Poor” have the same meanings.

TABLE 2

| | | | | | | | Liquid | | | | |
|---|---|---|---|---|---|---|---|---|---|---|---|
| | Alignment layer | | | | | | crystal layer | | | | |
| | | | | | Fluorine | C1-C3 | Liquid | | | | |
| | | | | Photocurable | concentration | total | crystal | | Evaluation | | |
| | Mold | p | D | composition | FC | concentration | composition | T3 | Rd | Diffracted | |
| | M | [nm] | [nm] | A | [at %] | [wt %] | L | [μm] | [nm] | light | Evaluation |
| Ex. 1 | M2 | 140 | 130 | A1 | 0 | 0.00 | L1 | 1 | 120 | Absent | Poor |
| Ex. 2 | M2 | 140 | 130 | A2 | 8 | 0.00 | L1 | 1 | 127 | Absent | Excellent |
| Ex. 3 | M2 | 140 | 130 | A3 | 11 | 0.00 | L1 | 1 | 129 | Absent | Excellent |
| Ex. 4 | M2 | 140 | 130 | A4 | 13 | 0.00 | L1 | 1 | 130 | Absent | Excellent |
| Ex. 5 | M2 | 140 | 130 | A5 | 10 | 0.48 | L1 | 1 | 127 | Absent | Excellent |
| Ex. 6 | M2 | 140 | 130 | A6 | 14 | 0.96 | L1 | 1 | 131 | Absent | Excellent |
| Ex. 7 | M2 | 140 | 130 | A7 | 19 | 0.96 | L1 | 1 | 127 | Absent | Excellent |
| Ex. 8 | M2 | 140 | 130 | A8 | 0 | 0.96 | L1 | 1 | 131 | Absent | Excellent |
| Ex. 9 | M2 | 140 | 130 | A9 | 14 | 0.96 | L1 | 1 | 133 | Absent | Excellent |
| Ex. 10 | M2 | 140 | 130 | A10 | 17 | 0.96 | L1 | 1 | 134 | Absent | Excellent |
| Ex. 11 | M2 | 140 | 130 | A11 | 20 | 0.96 | L1 | 1 | 146 | Absent | Excellent |

As is clear from TABLE 2, in Examples 2 to 12, different from Example 1, the alignment layer contained fluorine, a surfactant or both, and thus the retardation Rd could be made greater than the retardation Rd in Example 1. In Examples 1 to 12, because the pitch p of the grooves was less than or equal to the 300 nm, diffracted light was not generated.

TABLE 3 shows results of evaluation of Examples 1, 9, and 12 to 23.

TABLE 3

| | | | | | | | Liquid | | | | |
|---|---|---|---|---|---|---|---|---|---|---|---|
| | Alignment layer | | | | | | crystal layer | | | | |
| | | | | | Fluorine | C1-C3 | Liquid | | | | |
| | | | | Photocurable | concentration | total | crystal | | Evaluation | | |
| | Mold | p | D | composition | FC | concentration | composition | T3 | Rd | Diffracted | |
| | M | [nm] | [nm] | A | [at %] | [wt %] | L | [μm] | [nm] | light | Evaluation |
| Ex. 12 | M1 | 90 | 130 | A9 | 14 | 0.96 | L1 | 1 | 134 | Absent | Excellent |
| Ex. 13 | M1 | 90 | 130 | A1 | 0 | 0.00 | L1 | 1 | 121 | Absent | Poor |
| Ex. 9 | M2 | 140 | 130 | A9 | 14 | 0.96 | L1 | 1 | 133 | Absent | Excellent |
| Ex. 1 | M2 | 140 | 130 | A1 | 0 | 0.00 | L1 | 1 | 120 | Absent | Poor |
| Ex. 14 | M3 | 277 | 50 | A9 | 14 | 0.96 | L1 | 1 | 130 | Absent | Excellent |
| Ex. 15 | M3 | 277 | 50 | A1 | 0 | 0.00 | L1 | 1 | 120 | Absent | Poor |
| Ex. 16 | M4 | 417 | 120 | A9 | 14 | 0.96 | L1 | 1 | 128 | Present | Excellent |
| Ex. 17 | M4 | 417 | 120 | A1 | 0 | 0.00 | L1 | 1 | 121 | Present | Poor |
| Ex. 18 | M5 | 555 | 130 | A9 | 14 | 0.96 | L1 | 1 | 133 | Present | Excellent |
| Ex. 19 | M5 | 555 | 130 | A1 | 0 | 0.00 | L1 | 1 | 122 | Present | Poor |
| Ex. 20 | M6 | 833 | 130 | A9 | 14 | 0.96 | L1 | 1 | 122 | Present | Poor |
| Ex. 21 | M6 | 833 | 130 | A1 | 0 | 0.00 | L1 | 1 | 119 | Present | Poor |
| Ex. 22 | M7 | 1111 | 140 | A9 | 14 | 0.96 | L1 | 1 | 112 | Present | Poor |
| Ex. 23 | M7 | 1111 | 140 | A1 | 0 | 0.00 | L1 | 1 | 122 | Present | Poor |

As is clear from TABLE 3, in Examples 12, 9, 14, 16, and 18, different from Examples 13, 1, 15, 17, and 19, since the alignment layer contained fluorine and a surfactant, the retardation Rd could be made greater than the retardation Rd in Examples 13, 1, 15, 17, and 19. However, although in Examples 20 and 22, different from Examples 21 and 23, the alignment layer contained fluorine and a surfactant, the retardation Rd could not be made greater than the retardation in Examples 21 and 23. TABLE 3 shows that if the pitch p of the grooves was greater than 600 nm, the effect of improving Rd could not be obtained even if the alignment layer contained fluorine and a surfactant. In Examples 1, 9, and 12 to 15, different from Examples 16 to 23, because the pitch p of the groove was less than or equal to 300 nm, diffracted light was not generated.

TABLE 4 shows results of evaluation of Examples 24 to 29.

TABLE 4

| | | | | | | | Liquid | | | | |
|---|---|---|---|---|---|---|---|---|---|---|---|
| | Alignment layer | | | | | | crystal layer | | | | |
| | | | | | Fluorine | C1-C3 | Liquid | | | | |
| | | | | Photocurable | concentration | total | crystal | | Evaluation | | |
| | Mold | p | D | composition | FC | concentration | composition | T3 | Rd | Diffracted | |
| | M | [nm] | [nm] | A | [at %] | [wt %] | L | [μm] | [nm] | light | Evaluation |
| Ex. 24 | M8 | 90 | 25 | A9 | 14 | 0.96 | L1 | 1 | 131 | Absent | Excellent |
| Ex. 25 | M8 | 90 | 25 | A1 | 0 | 0.00 | L1 | 1 | 119 | Absent | Poor |
| Ex. 26 | M9 | 140 | 40 | A9 | 14 | 0.96 | L1 | 1 | 132 | Absent | Excellent |
| Ex. 27 | M9 | 140 | 40 | A1 | 0 | 0.00 | L1 | 1 | 119 | Absent | Poor |
| Ex. 28 | M10 | 140 | 15 | A9 | 14 | 0.96 | L1 | 1 | 129 | Absent | Excellent |
| Ex. 29 | M10 | 140 | 15 | A1 | 0 | 0.00 | L1 | 1 | 118 | Absent | Poor |

As is clear from TABLE 4, in Examples 24, 26, and 28, different from Examples 25, 27, and 29, the alignment layer contained fluorine and a surfactant, and thus the retardation Rd could be made greater than the retardation Rd in Examples 25, 27, and 29. TABLE 4 shows that when the depth D of the groove was greater than or equal to 3 nm, the effect of the alignment layer containing fluorine, a surfactant, or both was obtained.

TABLE 5 shows results of evaluation of Examples 30 to 35.

TABLE 5

| | | | | | | | Liquid | | | | |
|---|---|---|---|---|---|---|---|---|---|---|---|
| | Alignment layer | | | | | | crystal layer | | | | |
| | | | | | Fluorine | C1-C3 | Liquid | | | | |
| | | | | Photocurable | concentration | total | crystal | | Evaluation | | |
| | Mold | p | D | composition | FC | concentration | composition | T3 | Rd | Diffracted | |
| | M | [nm] | [nm] | A | [at %] | [wt %] | L | [μm] | [nm] | light | Evaluation |
| Ex. 30 | M1 | 90 | 130 | A10 | 17 | 0.96 | L2 | 1 | 146 | Absent | Excellent |
| Ex. 31 | M1 | 90 | 130 | A1 | 0 | 0.00 | L2 | 1 | 139 | Absent | Poor |
| Ex. 32 | M2 | 140 | 130 | A10 | 17 | 0.96 | L2 | 1 | 145 | Absent | Excellent |
| Ex. 33 | M2 | 140 | 130 | A1 | 0 | 0.00 | L2 | 1 | 138 | Absent | Poor |
| Ex. 34 | M5 | 555 | 130 | A10 | 17 | 0.96 | L2 | 1 | 143 | Present | Excellent |
| Ex. 35 | M5 | 555 | 130 | A1 | 0 | 0.00 | L2 | 1 | 135 | Present | Poor |

As is clear from TABLE 5, in Examples 30, 32, and 34, different from Examples 31, 33, and 35, the alignment layer contained fluorine and a surfactant, and thus the retardation Rd could be made greater than the retardation Rd in Examples 31, 33, and 35. In Example 32, different from Example 10, since the liquid crystal composition containing a surfactant (liquid crystal composition L2) was used as the liquid crystal composition, the retardation Rd could be made greater than the retardation Rd in Example 10, in which the liquid crystal composition L1 was used. It was found that when the liquid crystal composition contained a surfactant, the difference between the retardation Rd in the case where the alignment layer contained fluorine and a surfactant and the retardation Rd in the case where the alignment layer did not contain fluorine and a surfactant became smaller (see Examples 1, 10, 32, and 33).

TABLE 6 shows results of evaluation of Examples 36 to 42.

TABLE 6

| | | | | | | | Liquid | | | | |
|---|---|---|---|---|---|---|---|---|---|---|---|
| | Alignment layer | | | | | | crystal layer | | | | |
| | | | | | Fluorine | C1-C3 | Liquid | | | | |
| | | | | Photocurable | concentration | total | crystal | | Evaluation | | |
| | Mold | p | D | composition | FC | concentration | composition | T3 | Rd | Diffracted | |
| | M | [nm] | [nm] | A | [at %] | [wt %] | L | [μm] | [nm] | light | Evaluation |
| Ex. 36 | M1 | 90 | 130 | A9 | 14 | 0.96 | L1 | 2 | 231 | Absent | Excellent |
| Ex. 37 | M1 | 90 | 130 | A1 | 0 | 0.00 | L1 | 2 | 220 | Absent | Poor |
| Ex. 38 | M2 | 140 | 130 | A10 | 17 | 0.96 | L1 | 2 | 236 | Absent | Excellent |
| Ex. 39 | M2 | 140 | 130 | A9 | 14 | 0.96 | L1 | 2 | 232 | Absent | Excellent |
| Ex. 40 | M2 | 140 | 130 | A1 | 0 | 0.00 | L1 | 2 | 222 | Absent | Poor |
| Ex. 41 | M5 | 555 | 130 | A9 | 14 | 0.96 | L1 | 2 | 231 | Present | Excellent |
| Ex. 42 | M5 | 555 | 130 | A1 | 0 | 0.00 | L1 | 2 | 221 | Present | Poor |

As is clear from TABLE 6, in Examples 36, 38 to 39, and 41, different from Examples 37, 40, and 42, the alignment layer contained fluorine and a surfactant, and thus the retardation Rd could be made greater than the retardation Rd in Examples 37, 40, and 42. Although, in Examples 36, 39 and 41, the thickness T3 of the liquid crystal layer was twice as large as the thickness T3 in Examples 12, 9 and 19, the effect of the alignment layer containing fluorine and a surfactant was obtained.

TABLE 7 shows results of evaluation of Examples 43 to 49.

TABLE 7

| | | | | | | | Liquid | | | | |
|---|---|---|---|---|---|---|---|---|---|---|---|
| | Alignment layer | | | | | | crystal layer | | | | |
| | | | | | Fluorine | C1-C3 | Liquid | | | | |
| | | | | Photocurable | concentration | total | crystal | | Evaluation | | |
| | Mold | p | D | composition | FC | concentration | composition | T3 | Rd | Diffracted | |
| | M | [nm] | [nm] | A | [at %] | [wt %] | L | [μm] | [nm] | light | Evaluation |
| Ex. 43 | M1 | 90 | 130 | A9 | 14 | 0.96 | L2 | 2 | 236 | Absent | Excellent |
| Ex. 44 | M1 | 90 | 130 | A1 | 0 | 0.00 | L2 | 2 | 228 | Absent | Poor |
| Ex. 45 | M2 | 140 | 130 | A10 | 17 | 0.96 | L2 | 2 | 245 | Absent | Excellent |
| Ex. 46 | M2 | 140 | 130 | A9 | 14 | 0.96 | L2 | 2 | 237 | Absent | Excellent |
| Ex. 47 | M2 | 140 | 130 | A1 | 0 | 0.00 | L2 | 2 | 223 | Absent | Poor |
| Ex. 48 | M5 | 555 | 130 | A9 | 14 | 0.96 | L2 | 2 | 234 | Present | Excellent |
| Ex. 49 | M5 | 555 | 130 | A1 | 0 | 0.00 | L2 | 2 | 226 | Present | Poor |

As is clear from TABLE 7, in Examples 43, 45 to 46, and 48, different from Examples 44, 47, and 49, the alignment layer contained fluorine and a surfactant, and thus the retardation Rd could be made greater than the retardation Rd in Examples 44, 47, and 49. Although, in Example 45, the thickness T3 of the liquid crystal layer was twice the thickness T3 in Example 32, the effect of the alignment layer containing fluorine and the surfactant was obtained. In Examples 43, 45 to 46, and 48, different from Examples 36, 38 to 39, and 41, since the liquid crystal composition containing a surfactant (liquid crystal composition L2) was used as the liquid crystal composition, the retardation Rd could be made greater than the retardation Rd in Examples 36, 38 to 39, and 41, in which the liquid crystal composition L1 was used.

As described above, an optical element and a method for manufacturing the same according to the present disclosure have been described. However, the present disclosure is not limited to the above-described embodiments and the like. Various variations, modifications, substitutions, additions, deletions, and combinations may be possible within the scope recited in claims. They of course also naturally fall within the technical scope of the present disclosure.

What is claimed is:

1. An optical element comprising:
a transparent substrate;
an alignment layer formed over the transparent substrate; and
a liquid crystal layer formed over the alignment layer, wherein
a plurality of grooves parallel to each other for aligning liquid crystal molecules of the liquid crystal layer are formed over a surface of the alignment layer in contact with the liquid crystal layer,
a pitch of the grooves is greater than or equal to 10 nm and less than or equal to 600 nm, and
the alignment layer is formed of a copolymer of an energy curable composition and contains fluorine on the surface.

2. The optical element according to claim 1, wherein
a concentration of fluorine is greater than or equal to 0.1 atom % and less than or equal to 50 atom %.

3. The optical element according to claim 1, wherein
the alignment layer contains a surfactant.

4. An optical element comprising:
a transparent substrate;
an alignment layer formed over the transparent substrate; and
a liquid crystal layer formed over the alignment layer, wherein
a plurality of grooves parallel to each other for aligning liquid crystal molecules of the liquid crystal layer are formed over a surface of the alignment layer in contact with the liquid crystal layer,
a pitch of the grooves is greater than or equal to 10 nm and less than or equal to 600 nm, and
the alignment layer is formed of a copolymer of an energy curable composition and contains a surfactant.

5. The optical element according to claim 4, wherein
a content of the surfactant in the alignment layer is greater than or equal to 0.05 mass % and less than or equal to 4 mass %.

6. The optical element according to claim 1, wherein
a thickness of the liquid crystal layer is greater than or equal to 0.3 μm and less than or equal to 30 μm.

7. The optical element according to claim 1, wherein
the transparent substrate is a three-dimensional structure having a curved surface, and
the alignment layer is formed over the curved surface of the transparent substrate.

8. The optical element according to claim 1, wherein
the transparent substrate is formed over a curved surface of a three-dimensional structure.

9. The optical element according to claim 1, wherein
the liquid crystal layer is a retardation layer or a compensation layer.

10. The optical element according to claim 1, wherein
a depth of the groove is greater than or equal to 3 nm and less than or equal to 500 nm.
